(19) United States
(12) Patent Application Publication
(10) Pub. No.: US 2026/0254080 A1
(43) Pub. Date: Aug. 27, 2026

(54) CAVITY PHASE SHIFTER AND BASE STATION ANTENNA

(71) Applicant: Outdoor Wireless Networks LLC, Richardson, TX (US)

(72) Inventors: Yan Wang, Suzhou (CN); Zunbiao Ge, Suzhou (CN); Hangsheng Wen, Suzhou (CN); Fangwen Wan, Suzhou (CN); Fei Li, Suzhou (CN)

(21) Appl. No.: 19/535,468

(22) Filed: Feb. 10, 2026

(30) Foreign Application Priority Data
Feb. 21, 2025 (CN) 202510195410.4

(51) Int. Cl. H01P 1/18

(52) U.S. Cl. CPC H01P 1/18

(57) ABSTRACT

A cavity phase shifter comprises a first cavity, a first main phase shifter circuit, a first moveable phase shift component, and a first sliding linkage for the first moveable phase shift component mounted within the first cavity; and a second cavity, a second main phase shifter circuit, a second moveable phase shift component, and a second sliding linkage for the second moveable phase shift component mounted within the second cavity. The first and second cavities are arranged side by side in a horizontal direction, and first and second grooves for at least partially exposing the respective first and second sliding linkages are provided on the cavity phase shifter. The first and second grooves are arranged side by side in the horizontal direction, and a dimension of the second groove is different from a dimension of the first groove.

### CROSS-REFERENCE TO RELATED APPLICATION

The present application claims priority to Chinese Patent Application No. 202510195410.4, filed February 21, 2025, the entire content of which is incorporated herein by reference as if set forth fully herein.

### FIELD

The present application generally relates to radio communications, and more particularly relates to a cavity phase shifter and a base station antenna.

### BACKGROUND

Cellular base stations are well known in the art, and generally comprise baseband units, radio units, antennas and other components. Antennas are configured to provide bidirectional radio frequency (“RF”) communication with fixed and mobile subscribers (“users”) located throughout the cell. Generally, antennas are installed on towers or raised structures such as poles, roofs, water towers, etc., and separate baseband units and radio units are connected to the antennas.

FIG. 1 is a structural schematic diagram of a conventional cellular base station 40. The cellular base station 40 generally comprises a base station antenna 100 that may be mounted on an antenna tower 44. The cellular base station 40 further comprises a baseband unit 41 and a radio unit 42. In order to simplify the attached drawing, a single baseband unit 41 and a single radio unit 42 are shown in FIG. 1. However, it should be understood that more than one baseband unit 41 and/or radio unit 42 may be provided. In addition, although the radio unit 42 is shown as being located at the same position as the baseband unit 41 at the bottom of the antenna tower 44, it should be understood that in other cases, the radio unit 42 may be a remote radio head (RRH) mounted on the antenna tower 44 adjacent to the base station antenna 100. The baseband unit 41 is capable of receiving data from another source (e.g., a backhaul network [not shown]), and is capable of processing the data and providing a data stream to the radio unit 42. The radio unit 42 may generate RF signals comprising data encoded therein and may amplify and transmit these RF signals to the base station antenna 100 through an RF cable 43 (e.g. a coaxial transmission cable). It should also be understood that the cellular base station 40 of FIG. 1 may generally also comprise various other devices (not shown), such as a power supply, a backup battery, a power bus, an antenna interface signal group (AISG) controller, and the like. Generally, a base station antenna 100 comprises one or a plurality of phased arrays of radiating elements, wherein the radiating elements are arranged in one or a plurality of columns when the antenna is installed for use.

In order to transmit and receive RF signals to and from the defined coverage area, the antenna beams generated by arrays of radiating elements that are included in the base station antenna 100 are generally inclined at a certain downward angle with respect to the horizontal plane (referred to as a “downtilt”). In some cases, the downtilt of the antenna beam is generated electrically by adjusting the relative phase of sub-components of RF signals fed to each sub-set of radiating elements in the array that generates the antenna beam. The amount of electric downtilt applied to antenna beams generated by the radiating element array of the base station antenna 100 is capable of, in some cases, being adjusted from a remote location. When the base station antenna 100 has such an electrical tilting capability, the physical orientation of the base station antenna 100 may remain fixed, but the effective inclination angle of a generated antenna beam (e.g., the peak of the antenna beam relative to the directional angle of the horizontal plane) may still be electrically adjustable, such as by controlling a phase shifter that adjusts the relative phase of sub-components of RF signals provided to each radiating element in an array in the base station antenna 100. The phase shifter and other related circuits are usually built in the base station antenna 100 and can be controlled from a remote location. Typically, an AISG control signal is used to control the phase shifter.

Each phase shifter and power divider is generally constructed together as part of a phase shift and feed network of the base station antenna 100, and the phase shift and feed network of the base station antenna 100 feeds RF signals received from the radio unit 42 to the radiating element array included in the base station antenna 100. The power divider divides the RF signals into a plurality of sub-components, and the phase shifter applies an adjustable phase shift to each sub-component individually so that each sub-component is fed to the corresponding sub-array comprising one or a plurality of radiating elements. Many different types of phase shifters are known in the art, including rotary wiper arm phase shifters, trombone style phase shifters, sliding dielectric phase shifters, and sliding metal phase shifters. Each of the above types of phase shifters may be implemented as a cavity phase shifter, wherein the phase shifter may be enclosed in a metal housing coupled to an electrical ground.

However, in some application scenarios, the radio frequency performance of the cavity phase shifter may exhibit a resonance. This is undesirable.

### SUMMARY

According to a first aspect of the present application, a cavity phase shifter is provided, which comprises: a first cavity within which a first main phase shifter circuit, a first moveable phase shift component associated with the first main phase shifter circuit, and a first sliding linkage for the first moveable phase shift component are mounted; a second cavity within which a second main phase shifter circuit, a second moveable phase shift component associated with the second main phase shifter circuit, and a second sliding linkage for the second moveable phase shift component are mounted, wherein the first cavity and the second cavity are arranged side by side to each other in a horizontal direction, wherein a first groove for at least partially exposing the first sliding linkage and a second groove for at least partially exposing the second sliding linkage are provided on the cavity phase shifter, wherein the first groove and the second groove are arranged side by side with each other in the horizontal direction, and a dimension of the second groove is different from a dimension of the first groove.

According to a second aspect of the present application, a cavity phase shifter is provided, comprising: a first cavity within which a first main phase shifter circuit, a first moveable phase shift component assigned to the first main phase shifter circuit, and a first sliding linkage for the first moveable phase shift component are mounted; a second cavity within which a second main phase shifter circuit, a second moveable phase shift component assigned to the second main phase shifter circuit, and a second sliding linkage for the second moveable phase shift component are mounted, wherein the first cavity and the second cavity are arranged side by side to each other in a horizontal direction, wherein a first groove for at least partially exposing the first sliding linkage and a second groove for at least partially exposing the second sliding linkage are provided on the cavity phase shifter, the first groove and the second groove are arranged side by side with each other in the horizontal direction, wherein the first groove and the second groove are differently designed such that a first resonant frequency point caused by the first groove is different from a second resonant frequency point caused by the second groove.

According to a third aspect of the present application, a cavity phase shifter is provided, comprising: a first metal cavity having a first opening that exposes a first sliding linkage that is mounted within the first metal cavity; a second metal cavity having a second opening that exposes a second sliding linkage that is mounted within the second metal cavity; wherein a size of the first opening is different that a size of the second opening.

According to a fourth aspect of the present application, a base station antenna is provided, comprising: the cavity phase shifter according to some examples of the present application; a radiating element array mounted in front of the cavity phase shifter; a remote electronic tilt unit, wherein a first member of the remote electronic tilt unit is configured to connect to the first sliding linkage exposed via the first groove, and a second member of the remote electronic tilt unit is configured to connect to the second sliding linkage exposed via the second groove.

### BRIEF DESCRIPTION OF THE DRAWING

FIG. 1 is a structural schematic diagram of a conventional cellular base station.

FIG. 2 is a schematic block diagram of a base station antenna.

FIG. 3 is a schematic diagram of a cavity phase shifter according to a first example of the present application, the cavity phase shifter being formed as a standard cavity phase shifter.

FIG. 4 is a schematic diagram of a cavity phase shifter according to a second example of the present application, the cavity phase shifter being formed as an offset cavity phase shifter.

FIG. 5 is a schematic diagram of a cavity phase shifter according to a third example of the present application, the cavity phase shifter being formed as a dual offset cavity phase shifter.

FIG. 6 is a partial schematic diagram of a printed circuit board, a moveable phase shift component, and a sliding linkage mounted within one cavity of the cavity phase shifter.

FIG. 7 and FIG. 8 are a partial rear perspective view and a rear view of the cavity phase shifter according to the first example of the present application, respectively.

FIG. 9 and FIG. 10 are a partial rear perspective view and a rear view of the cavity phase shifter according to the second example of the present application, respectively.

FIG. 11 and FIG. 12 are a partial rear perspective view and a rear view of the cavity phase shifter according to the third example of the present application, respectively.

FIG. 13 to FIG. 20 are exemplary design schemes for a first groove and a second groove of a cavity phase shifter according to some examples of the present application, respectively.

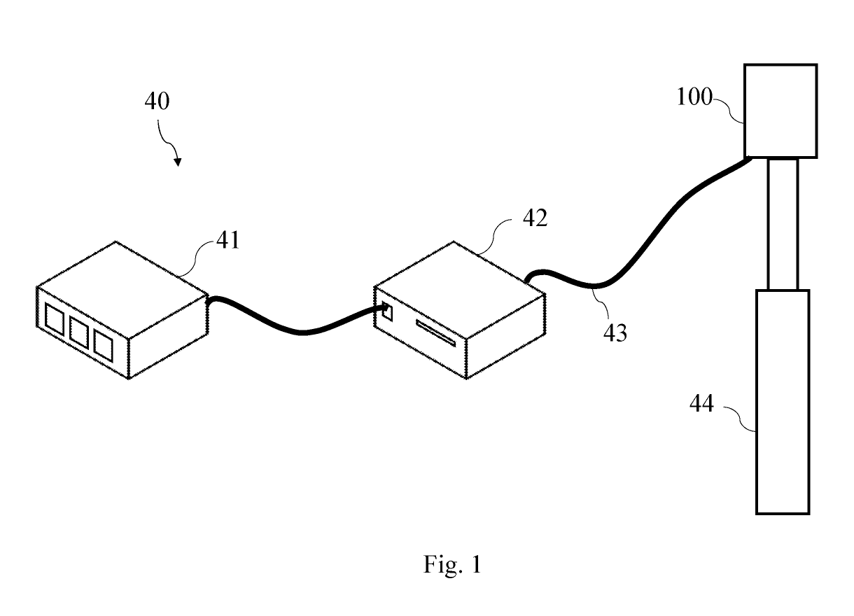

### DETAILED DESCRIPTION

The present application will be described below with reference to the attached drawings, wherein the attached drawings illustrate certain examples of the present application. However, it should be understood that the present application may be presented in many different ways and is not limited to the examples described below; in fact, the examples described below are intended to make the disclosure of the present application more complete and to fully explain the protection scope of the present application to those skilled in the art. It should also be understood that the examples disclosed in the present application may be combined in various ways so as to provide more additional examples.

In various examples of different descriptions, same reference numerals or same element names are configured for same elements, wherein the disclosures contained in the full text of the Specification can be transferred to elements having same reference numerals or same element names as intended. Further, in various examples, the number of elements, implementations, and/or arrangement structures are not limited to the illustrated examples, but are capable of selecting other quantities, implementations, and/or arrangement structures according to actual needs.

As used herein, spatial relational terms such as “above,” “below,” “left,” “right,” “front,” “back,” “high,” “low,” and the like are used to describe the relationship of one feature to another feature in the attached drawings. It should be understood that spatial relational terms, in addition to the orientations shown in the attached drawings, also encompass different orientations of the apparatus during use or operation. For example, when the apparatus is flipped in the attached drawings, a feature previously described as “below” another feature may now be described as “above” that other feature. The apparatus may also be oriented in other ways (rotated 90 degrees or in other orientations), and the relative spatial relationships will be interpreted accordingly in those cases.

As used herein, the term “A or B” comprises “A and B” and “A or B”, not exclusively “A” or “B”, unless otherwise specified.

As used herein, the terms “illustrative” or “exemplary” mean “serving as an example, instance, or illustration,” rather than as a “model” to be precisely replicated. Any realization method described exemplarily herein is not necessarily interpreted as being preferable or advantageous over other realization methods. Furthermore, the present application is not limited by any expressed or implied theory given in the above technical field, background art, summary of the invention or embodiments.

As used herein, the term “substantially” means encompassing slight variations resulting from design or manufacturing defects, tolerances of components or elements, environmental influences, and/or other factors.

As used herein, the term “part” may be a part of any proportion. For example, it may be larger than 10%, 20%, 30%, 40%, 114%, 60%, 70%, 80%, 90%.

In addition, for reference purposes only, “first,” “second,” and similar terms may also be used herein, and thus are not intended to be limiting. For example, unless the context clearly indicates, the words “first”, “second” and other such numerical words involving structures or elements do not imply a sequence or order.

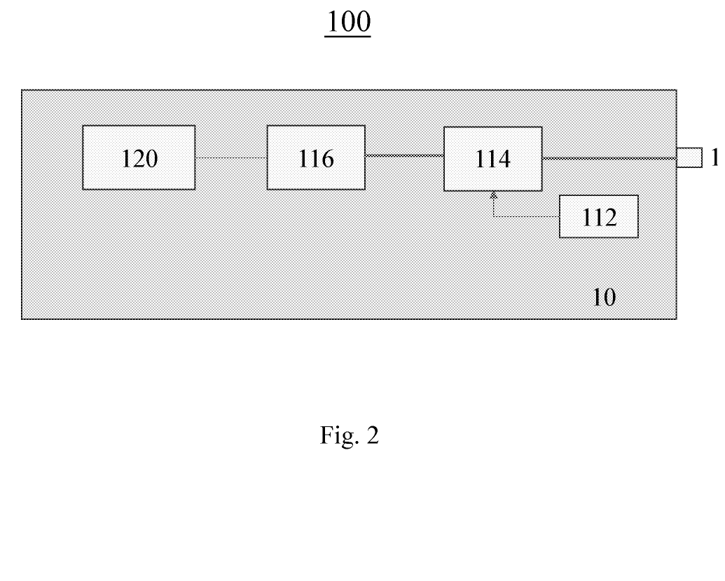

FIG. 2 is a schematic block diagram of a base station antenna 100. The base station antenna 100 usually comprises a radome (not shown) that provides environmental protection. As shown in FIG. 2, the base station antenna 100 may comprise a radio frequency port 110, a remote electronic tilt unit 112 (also known as an RET unit), a phase shifter 114, a feeder panel 116, and a radiating element array 120, and various other components that are not depicted in FIG. 2.

The base station antenna 100 may generally comprise a reflecting plate 10. The reflecting plate 10 may comprise a metallic primary surface, and the metallic primary surface provides a ground plane for the radiating element array 120 and reflects electromagnetic radiation directed backward from the radiating element back to a forward direction. When using the cavity phase shifter 114, in some examples, the reflecting plate 10 of the base station antenna 100 may be at least partially formed by combining front surfaces of a plurality of cavity phase shifters 114. In some examples, the base station antenna 100 may comprise a separate reflecting plate 10, and the cavity phase shifter 114 may be mounted to a rear side of the reflecting plate 10 via the front surface thereof.

Each radiating element of the radiating element array 120 may be mounted to extend forward (i.e. in the forward direction F) from the reflecting plate 10. Each radiating element linear array may comprise a plurality of radiating elements arranged along a longitudinal direction V of the antenna 100. The longitudinal direction or vertical direction V may be a direction of a longitudinal axis of the antenna or may be parallel to the longitudinal axis. The longitudinal direction or vertical direction V is perpendicular to the horizontal direction H and the forward direction F. As used herein, the term “vertical” does not necessarily require the object to be fully vertical (e.g., the antenna may have a small mechanical downtilt).

Each linear array may be connected to two ports of an external radio unit 42 (one port for each polarization). Each radio frequency port 110 of the antenna 100 may be configured to receive an RF signal from a respective port of the radio unit 42 (e.g., a first polarized RF signal) and transmit it to a phase shifter 114. The phase shifter 114 may generally comprise a phase shift circuit and a power divider circuit (abbreviated as a phase shift and feed line), which allows for the application of a phase taper to a plurality of subcomponents of the RF signal. By adjusting the amount of the phase taper applied, the antenna beams may be electronically downtilted to a desired angle.

The phase shifter 114 may be configured to receive the RF signal and divide it into a plurality of sub-components, each of which may be fed to the first polarized radiators of a respective subset of the radiating elements in a linear array. The various sub-components of the RF signal may be transmitted by each of the first polarized radiators of the linear array, thereby creating a first polarized antenna beam covering a generally fixed coverage area (e.g., a 120° sector of a cell). Typically, these linear arrays have a remote electronic tilt (“RET”) function (implemented by the RET unit), which allows a cellular network operator to electronically change the pointing angle of the antenna beams in the elevation plane (i.e., the downtilt angle of the antenna beam) from a remote location (e.g., the control center). By electronically changing the downtilt angle of the antenna beam, the cellular network operator can effectively change the sector size of the antenna service because the downtilt angle determines the distance at which the antenna beam extends from the base station.

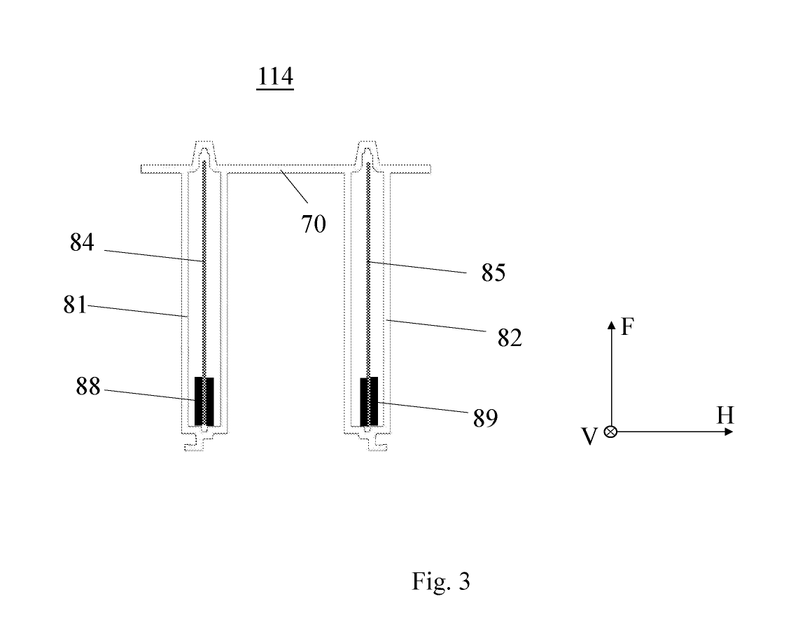

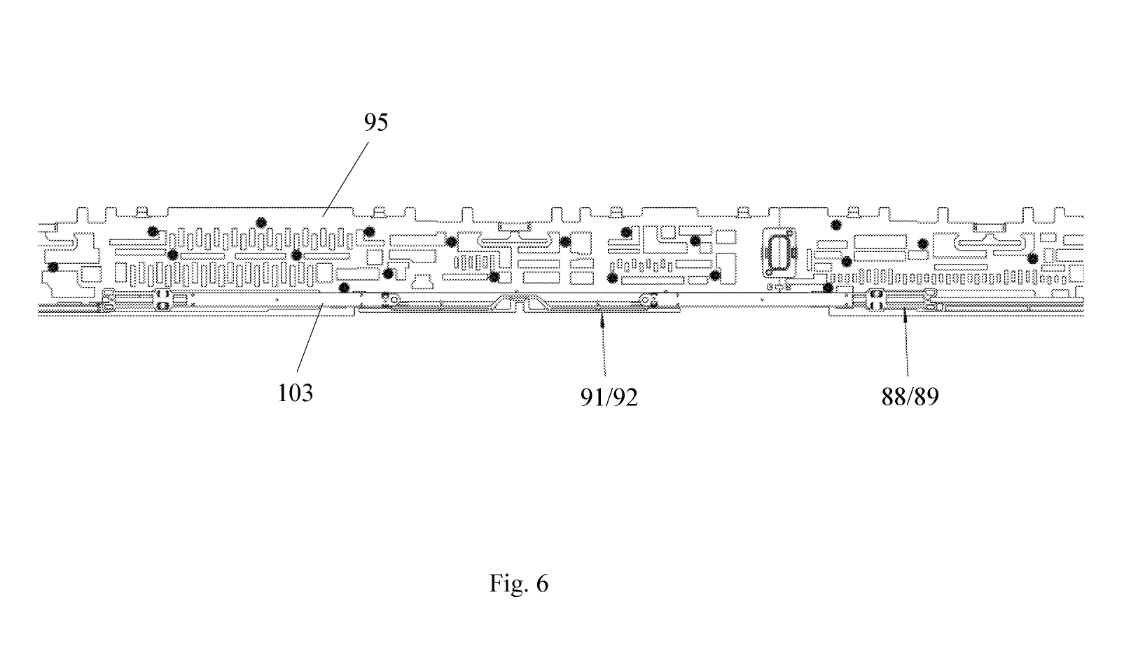

Further details of the cavity phase shifter 114 according to some examples of the present application are provided with reference to FIG. 3 to FIG. 6. FIG. 3 to FIG. 5 are schematic diagrams of cavity phase shifters 114. FIG. 6 is a partial schematic diagram of a printed circuit board 95, moveable phase shift components 88, 89, and sliding linkages 91, 92 mounted within a cavity of the cavity phase shifter 114.

The cavity phase shifter 114 may comprise a pair of cavities, i.e., a first cavity 81 and a second cavity 82 arranged side by side with each other in the horizontal direction H. A first main phase shifter circuit 84, a first moveable phase shift component 88, and a first sliding linkage 91 for the first moveable phase shift component 88 may be mounted within the first cavity 81 of the cavity pair of the cavity phase shifter 114(see FIG. 6). A second main phase shifter circuit 85, a second moveable phase shift component 89, and a second sliding linkage 92 for the second moveable phase shift component 89 may be mounted in the second cavity 82 of the cavity pair of the cavity phase shifter 114(see FIG. 6).

The first main phase shifter circuit 84 and the second main phase shifter circuit 85 may comprise, for example, the fixed portion of a wiper arm phase shifter or of a sliding dielectric or trombone phase shifter. The first main phase shifter circuit 84 and the second main phase shifter circuit 85 may each comprise, for example, an input port, one or more power dividers, transmission lines and a plurality of output ports. The first moveable phase shift component 88 and the second moveable phase shift component 89 may comprise, for example, the wiper arm of a wiper arm phase shifter, the sliding dielectric components of a sliding dielectric phase shifter, or the sliding portion of a trombone phase shifter.

In some examples, the first main phase shifter circuit 84 and the second main phase shifter circuit 85 may be implemented using printed circuit boards 95. In other examples, the first main phase shifter circuit 84 and/or the second main phase shifter circuit 85 may be implemented as conductive metal lines.

In some examples (e.g., in a sliding dielectric phase shifter implementation), the first moveable phase shift component 88 may be formed as a sheet or strip of dielectric material that is movably arranged on side faces of the first main phase shifter circuit 84, such as two sheets or strips of dielectric material that are movably mounted on the opposed major surfaces of the first main phase shifter circuit. The second moveable phase shift component 89 may similarly be formed as a pair of sheets or strips of dielectric material that are movably mounted on the opposed major surfaces of the second main phase shifter circuit . In some examples, a plurality of sheets or strips of dielectric material 103 may be connected sequentially along the longitudinal direction V to form a longitudinally-extending strip or sheet of dielectric material.

In some examples, the first sliding linkage 91 may be fixedly connected to the first moveable phase shift component 88, and the first sliding linkage 91 may drive the first moveable phase shift component 88 to move on the side face of the first main phase shifter circuit 84, thereby achieving a phase shifting function. The second sliding linkage 92 may be fixedly connected to the second moveable phase shift component 89, and the second sliding linkage 92 may drive the second moveable phase shift component 89 to move on the side face of the second main phase shifter circuit 85, thereby achieving the phase shifting function.

As shown in FIG. 3, the cavity phase shifter 114 may be formed as a conventional cavity phase shifter, which may comprise a conventional cavity pair, and a first cavity 81 and a second cavity 82 of the conventional cavity pair are spaced apart from one another in the horizontal direction H via a transition face 70. A first main phase shifter circuit 84 for a first polarized RF signal may be mounted within the first cavity 81, for example; and a second main phase shifter circuit 85 for a second polarized RF signal may be mounted within the second cavity 82, for example. Bipolarized feeds for the radiating elements are thereby achieved.

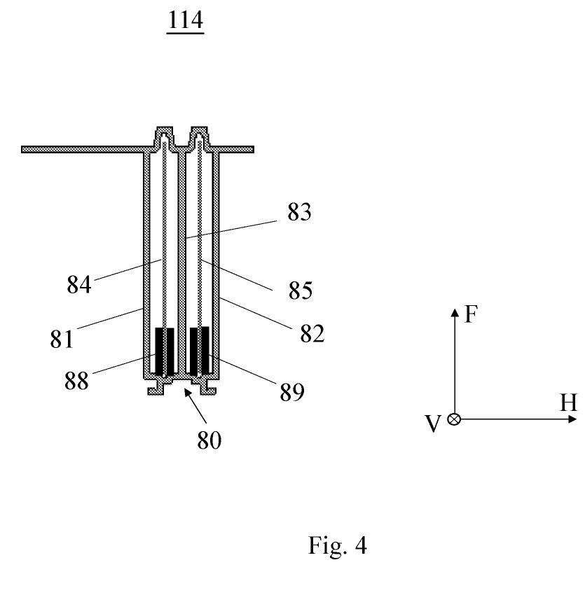

As shown in FIG. 4, the cavity phase shifter 114 may be formed as an offset cavity phase shifter 114, which may comprise an offset cavity pair. Different from the conventional cavity pair of FIG. 3, the first cavity 81 and the second cavity 82 of the offset cavity pair may be attached to each other in the horizontal direction H and separated by a common separation wall 83. Accordingly, such offset cavity pair may advantageously have a compact structure. A first main phase shifter circuit 84 for a first polarized RF signal may be mounted within the first cavity 81, for example; and a second main phase shifter circuit 85 for a second polarized RF signal may be mounted within the second cavity 82, for example. Bipolarized feeds for the radiating element are thereby achieved.

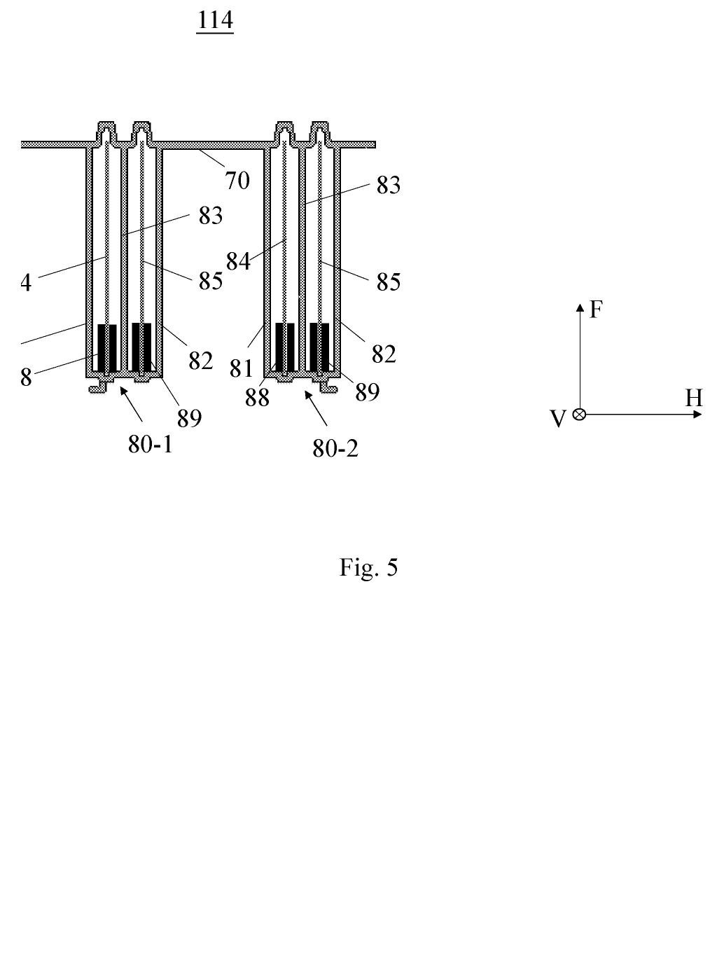

As shown in FIG. 5, the cavity phase shifter 114 may be formed as a dual offset cavity phase shifter 114, i.e., the cavity phase shifter 114 may have two offset cavity pairs arranged side by side with each other in the horizontal direction H, i.e., a first offset cavity pair 80-1 and a second offset cavity pair 80-2. The first cavity 81 and the second cavity 82 of each offset cavity pair may be attached to each other in the horizontal direction H and separated by a common separation wall 83. Further, the two offset cavity pairs may be spaced apart from one another by one transition face 70 in the horizontal direction H. Such dual offset cavity phase shifter 114 may be formed to be used for multi-frequency band operation for antennas. The first main phase shifter circuit 84 for the first polarized RF signal for a first operating frequency band may be mounted within the first cavity 81 of the first offset cavity pair 80-1, and a second main phase shifter circuit 85 for the first polarized RF signal for a second operating frequency band may be mounted within the second cavity 82 of the first offset cavity pair 80-1. The first main phase shifter circuit 84 for the second polarized RF signal for the first operating frequency band may be mounted within the first cavity 81 of the first offset cavity pair 80-2, and the second main phase shifter circuit 85 for the second polarized RF signal for the second operating frequency band may be mounted within the second cavity 82 of the first offset cavity pair 80-2. This allows for multi-frequency band operation of the antenna.

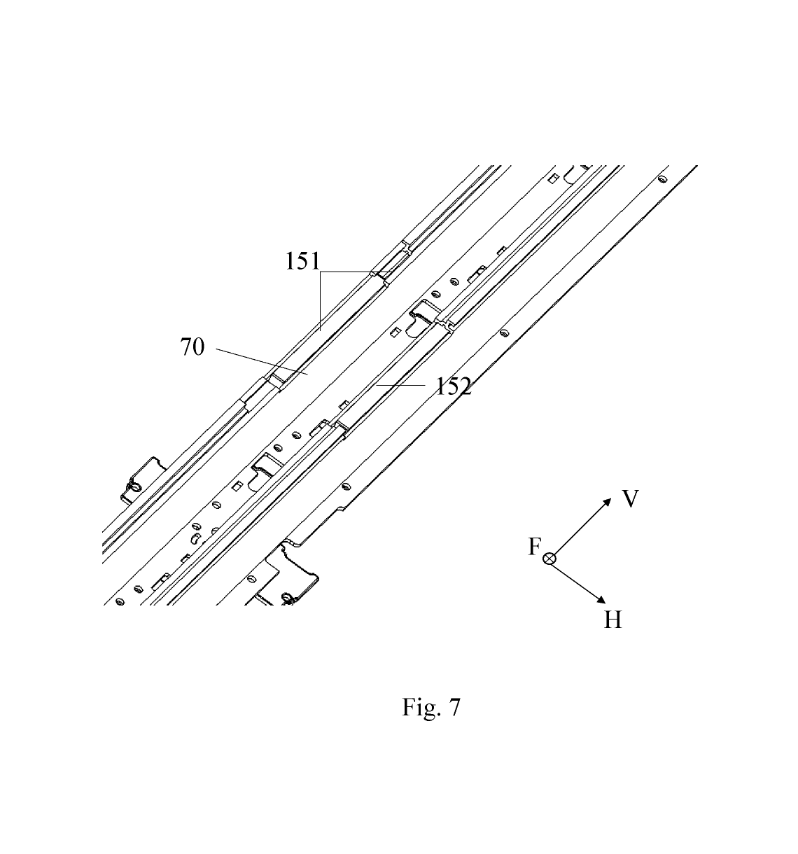

Referring to FIGS. 7-18, a first groove 151 for at least partially exposing the first sliding linkage 91 and a second groove 152 for at least partially exposing the second sliding linkage 92 may be provided on the cavity phase shifter 114. In other words, a respective window may be provided on the cavity phase shifter 114 to allow a member of the RET unit to be capable of accessing and connecting to the respective sliding linkage and to drive the sliding linkage to move within the cavity under the drive of a motor, thereby achieving the phase shifting function of the cavity phase shifter 114. In some examples, a first member of the RET unit may be configured to connect to the first sliding linkage 91 exposed via the first groove 151, and a second member of the RET unit may be configured to connect to the second sliding linkage 92 exposed via the second groove 152.

In some examples, the first groove 151 may be located on a rear surface of the first cavity 81 and the second groove 152 may be located on a rear surface of the second cavity 82, such that the first groove 151 and the second groove 152 may be arranged side by side with each other in the horizontal direction H on a rear surface of the cavity phase shifter 114.

However, providing the first groove 151 and the second groove 152 on the cavity phase shifter 114 may cause undesirable resonance, and the resonant frequencies may fall within the operating frequency band of the antenna, thereby negatively affecting the radio frequency performance of the antenna.

In some application scenarios, RF radiation may leak out of the cavity through the grooves, thereby causing insertion loss and/or return loss performance reduction of the antenna. To address such leakage, sliding linkages with metal plating that are capable of shielding RF radiation from outward leakage may be employed. However, such solution is not ideal for manufacturing processes and/or manufacturing costs.

In some application scenarios, a resonant current flow path may be formed between the first groove 151 and the second groove 152, thereby causing undesirable interference between adjacent cavities, and resulting in a decreased isolation performance of the antenna. To improve the isolation performance, coupling may be reduced using adjustment components. However, such solution would have adverse factors in manufacturing cost and/or structural compactness, while also having difficulty in obtaining satisfactory effects in temperature cycling testing.

Pursuant to certain embodiments of the present invention, cavity phase shifters such as cavity phase shifter 114 are provided that include a first groove 151 and a second groove 152 on a cavity pair of the cavity phase shifter 114 where the first and second grooves 151, 152 are designed such that a first resonant frequency point caused by the first groove 151 is different from a second resonant frequency point caused by the second groove 152. In other words, a resonant current generated at the first groove 151 and a resonant current generated at the second groove 152 should occur at different resonant frequency points, which suppresses the resonant current flow path mentioned above. This may not only reduce the extent of leakage of RF radiation, but may also reduce undesirable interference between adjacent cavities. In some examples, the first groove 151 and the second groove 152 may be differently designed such that at least one resonant frequency point of the radio frequency characteristic curve of the cavity phase shifter 114 is transferred outside of its operating frequency band. The radio frequency characteristic curve may comprise, for example, a return loss characteristic curve, an insertion loss characteristic curve, and/or an isolation characteristic curve.

In some examples, the first groove 151 and the second groove 152 may have different dimensions. It will be understood that the difference in dimensions relates to a dimension deviation that is specifically dictated without ignoring manufacturing tolerances.

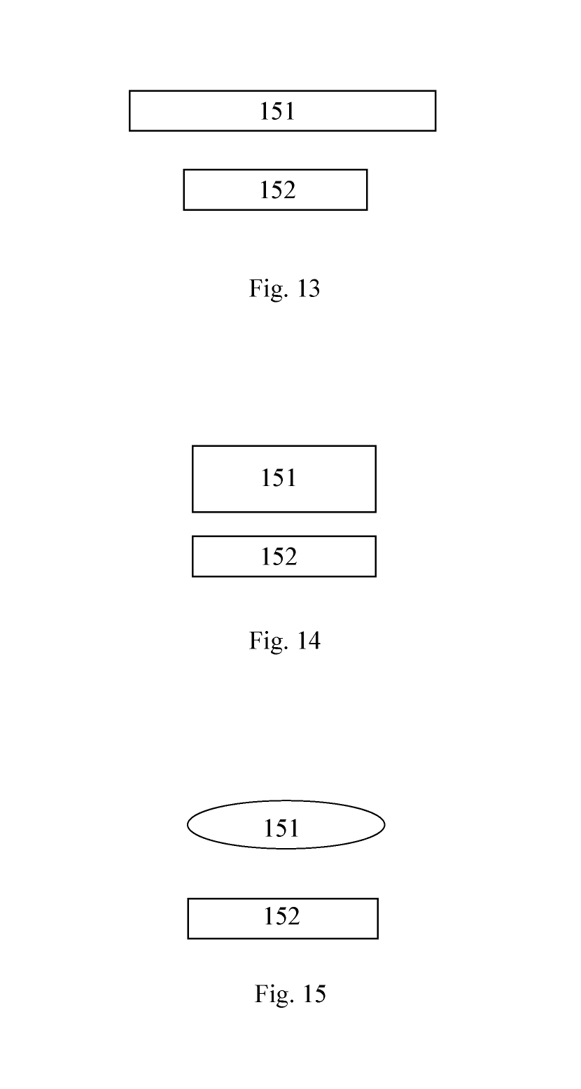

In some examples, the first groove 151 and the second groove 152 may have different length dimensions. As shown in FIG. 13 and FIG. 16 to FIG. 18, a length of the first groove 151 may be greater than a length of the second groove 152. In some examples, the length of the first groove 151 may be between 110% to 200% or between 120% to 180% of the length of the second groove 152. The first groove 151 may comprise a main section 151-1 and an extended section 151-2 extending along the longitudinal direction V from the main section 151-1. The second groove 152 may be substantially the same as the main section 151-1 of the first groove 151 in length, and the first groove 151 may be longer than the second groove 152 based on the extended section 151-2.

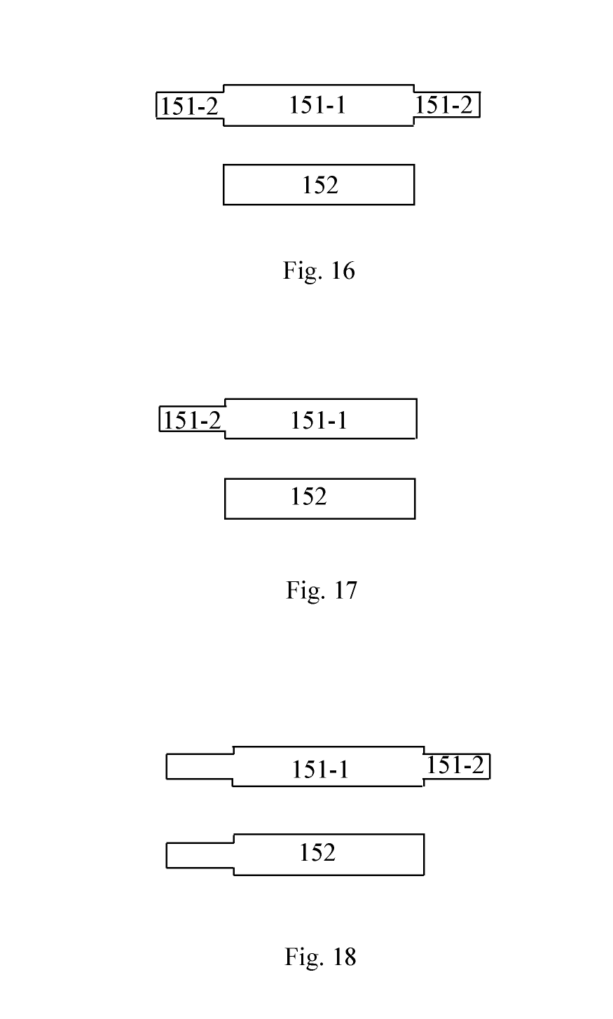

In some examples, the first groove 151 may comprise a first extended section 151-2 at a first side of the main section 151-1 and a second extended section 151-2 at a second side of the main section 151-1. Advantageously, a dimension of the first extended section 151-2 may be substantially the same as a dimension of the second extended section 151-2, thereby forming a substantially symmetrical groove structure, as shown in FIG. 13 and FIG. 16. In other examples, the first groove 151 may also have an extended section 151-2 only on one side, as shown in FIG. 17 and FIG. 18.

In some examples, an average width of the extended section 151-2 of the first groove 151 may be less than an average width of the main section 151-1, as shown in FIG. 16 to FIG. 18. That is, the extended section 151-2 of the first groove 151 may be designed to be relatively narrow, thereby avoiding accidental drop of a media sheet section or media strip section 103 of the moveable phase shift component from the first groove 151, as the extended first groove 151 may be longer than the media sheet section or media strip section 103. In some examples, the first groove 151 and the second groove 152 may be differently designed in terms of width dimensions. As shown in FIG. 14, an average width of the first groove 151 may be greater than an average width of the second groove 152. In some examples, the average width of the first groove 151 may be between 110% to 200% or between 120% to 180% of the average width of the second groove 152.

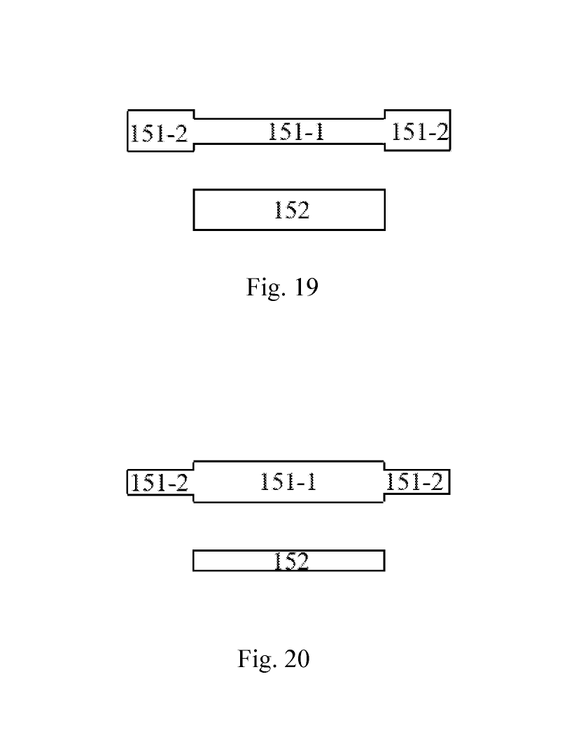

In some examples, the average width of the extended section 151-2 of the first groove 151 can be greater than the average width of the main section 151-1, as shown in FIG. 19. That is, the main section 151-1 of the first groove 151 can be relatively narrow in design, and thus the average width of the main section 151-1 of the first groove 151 is less than the average width of the second groove 152, to prevent an accidental drop of a media sheet section or media strip section 103 of the moveable phase shift component from the first groove 151, as the extended first groove 151 may be longer than the media sheet section or media strip section 103.

In some examples, the average width of the main section 151-1 of the first groove 151 can also be greater than the average width of the second groove 152, as shown in FIG. 20.

In some examples, the first groove 151 and the second groove 152 may be differently designed in terms of shapes. It will be understood that the difference in shape relates to a shape deviation that is specifically prescribed without ignoring manufacturing tolerances. As shown in FIG. 15, the first groove 151 may be designed to be in a shape different from a rectangle, such as an oval hole, while the second groove 152 may be designed to be substantially rectangular. It will be understood that the difference in contour shapes between the first groove 151 and the second groove 152 may be diverse and should not be limited to the current exemplary examples.

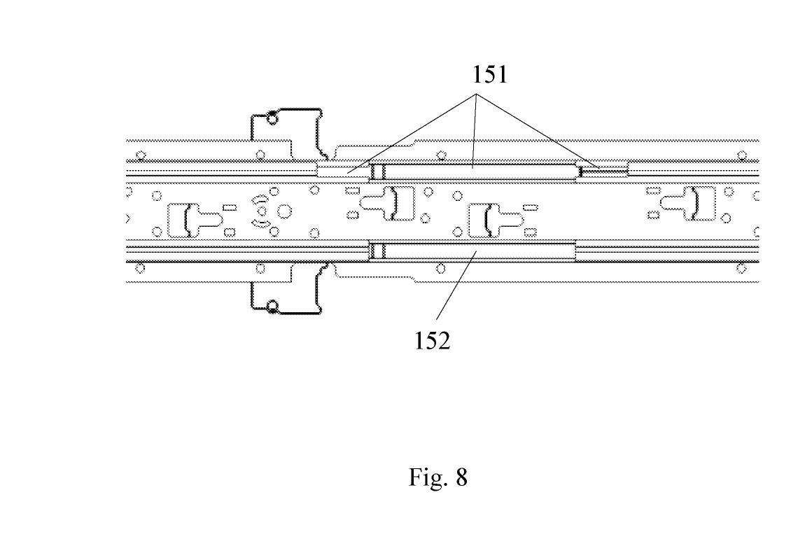

FIG. 7 and FIG. 8 are a partial rear perspective view and a rear view, respectively, of the cavity phase shifter 114 according to a first example of the present application. The cavity phase shifter 114 may be formed as a conventional cavity phase shifter 114 as shown in FIG. 3. The first cavity 81 and the second cavity 82 may be spaced apart from one another in the horizontal direction H via one transition face 70 such that the first groove 151 and the second groove 152 are spaced apart from one another in the horizontal direction H. In the illustrated example, the first groove 151 may be longer than the second groove 152.

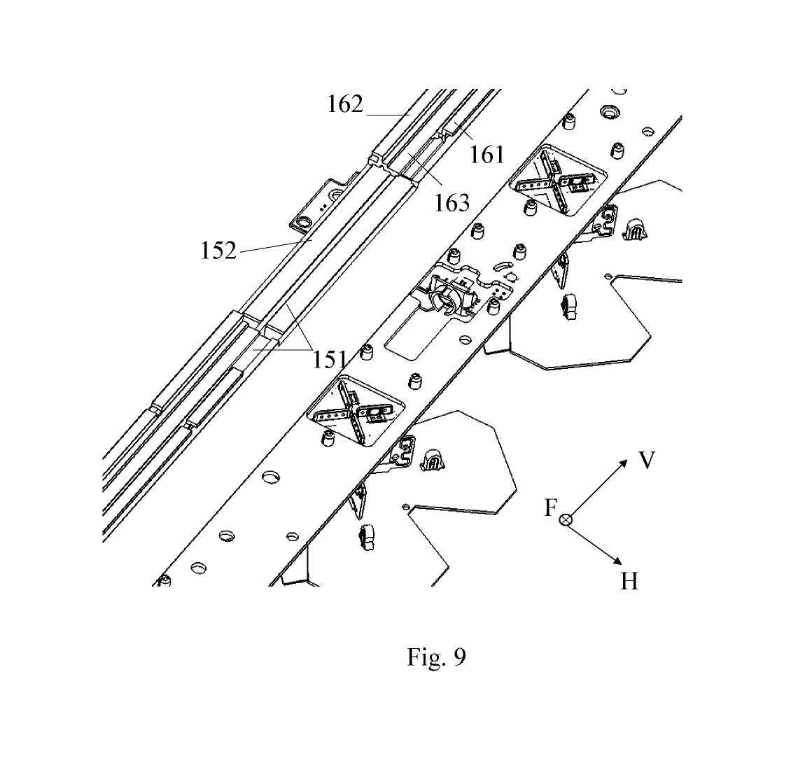

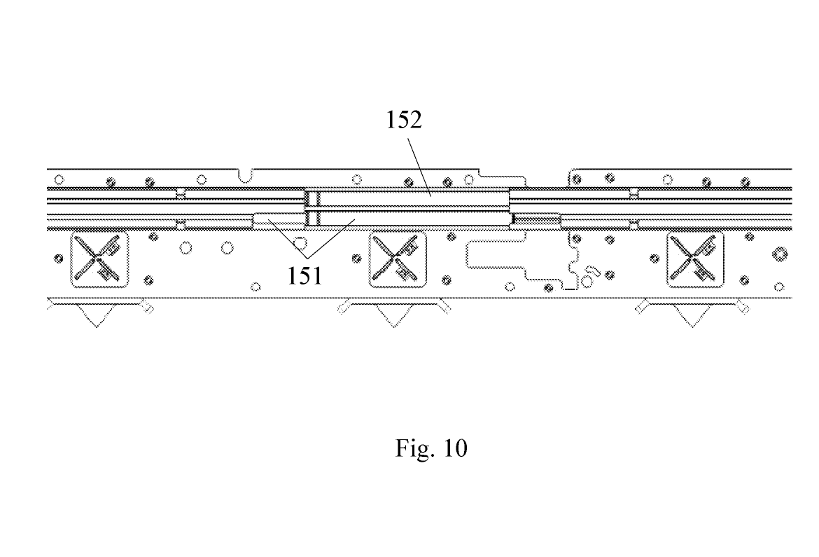

FIG. 9 and FIG. 10 are a partial rear perspective view and a rear view, respectively, of the cavity phase shifter 114 according to a second example of the present application. The cavity phase shifter 114 may be formed as a conventional offset cavity phase shifter 114, as shown in FIG. 4. The first cavity 81 and the second cavity 82 are attached to each other in the horizontal direction H and separated by a common separation wall 83 such that the first groove 151 and the second groove 152 are attached to each other in the horizontal direction H and separated by the separation wall 83. Further, the first cavity 81 may have a first hollow channel 161 protruding rearward and the second cavity 82 may have a second hollow channel 162 protruding rearward. The respective hollow channel may extend substantially along the longitudinal direction V. One transition face 163 may be formed between the first hollow channel 161 and the second hollow channel 162. As shown in FIG. 9 and FIG. 10, within regions of the first groove 151 and the second groove 152, not only the first hollow channel section and the second hollow channel section, but also the transition face section therebetween are excised. In the illustrated example, the first groove 151 may be longer than the second groove 152.

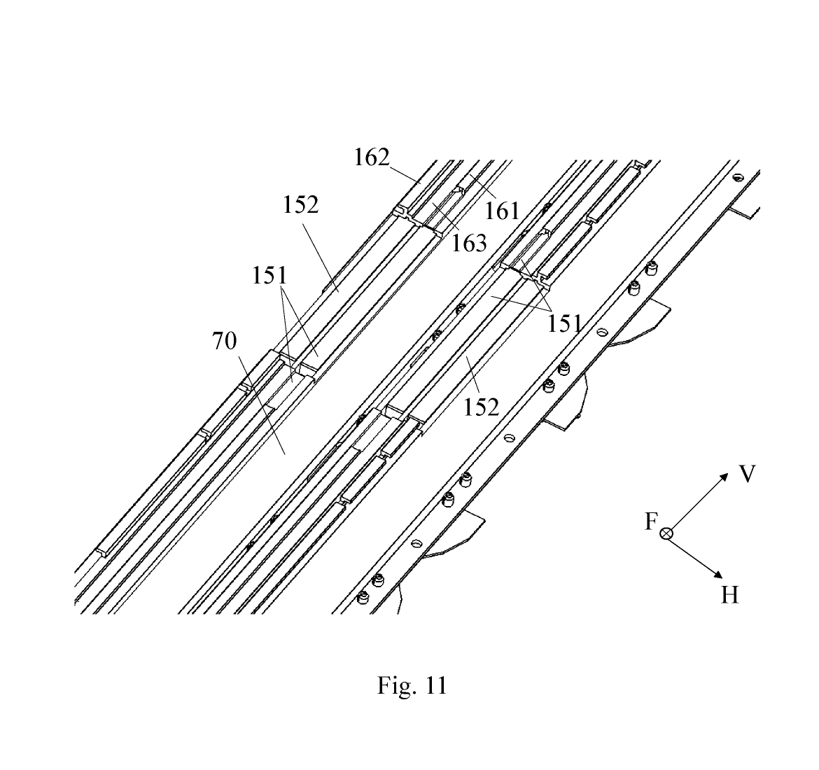

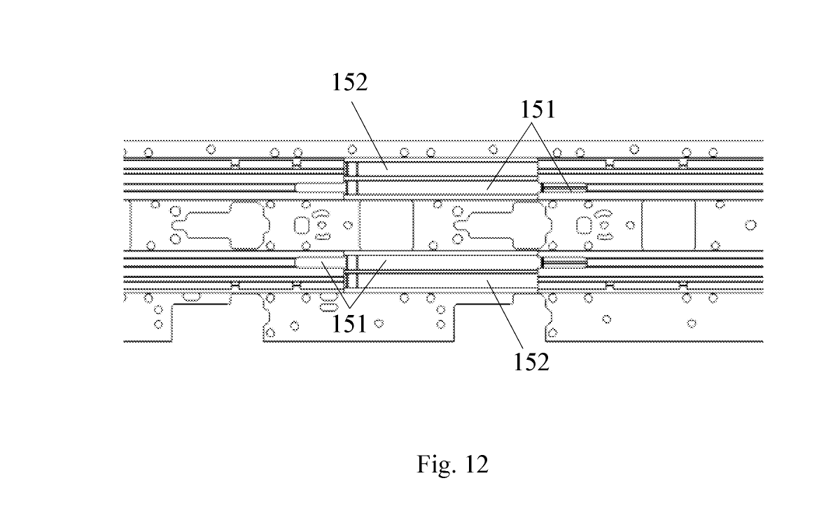

FIG. 11 and FIG. 12 show a partial rear perspective view and a rear view of the cavity phase shifter 114 according to a third example of the present application, respectively. The cavity phase shifter 114 may be formed as a dual offset cavity phase shifter 114, as shown in FIG. 5. The cavity phase shifter 114 is formed as a cavity phase shifter 114 for multi-frequency band operation, wherein the cavity phase shifter 114 comprises two offset cavity pairs, and the two offset cavity pairs are spaced apart from one another via the transition face 70 in the horizontal direction H. The first cavity 81 and the second cavity 82 of each offset cavity pair are attached to each other in the horizontal direction H and separated by a common separation wall 83 such that the first groove 151 and the second groove 152 are attached to each other in the horizontal direction H and separated by the separation wall 83. Further, the first cavity 81 may have a first hollow channel 161 protruding rearward and the second cavity 82 may have a second hollow channel 162 protruding rearward. The respective hollow channel may extend substantially along the longitudinal direction V. One transition face 163 may be formed between the first hollow channel 161 and the second hollow channel 162. As shown in FIG. 11 and FIG. 12, within regions of the first groove 151 and the second groove 152, not only the first hollow channel section and the second hollow channel section, but also the transition face section therebetween are excised. In the illustrated example, the first groove 151 may be longer than the second groove 152.

It should be understood that the various examples presented in the present application may be implemented separately from each other or in combination with each other, and should not be limited to the presently presented examples themselves.

Although some specific examples of the present application have been described in detail through examples, those skilled in the art should understand that the above embodiments are only for illustration rather than for limiting the scope of the present application. Various examples disclosed herein can be combined arbitrarily without departing from the spirit and scope of the present application. Those skilled in the art should also understand that various modifications may be made to the examples without departing from the scope and spirit of the present application. The scope of the present application is defined by the attached claims.

What is claimed is:

1. A cavity phase shifter, comprising:
a first cavity;
a first main phase shifter circuit, a first moveable phase shift component associated with the first main phase shifter circuit, and a first sliding linkage for the first moveable phase shift component that are each mounted in the first cavity;
a second cavity;
a second main phase shifter circuit, a second moveable phase shift component associated with the second main phase shifter circuit, and a second sliding linkage for the second moveable phase shift component that are each mounted in the second cavity,
wherein the first cavity and the second cavity are arranged side by side in a horizontal direction,
wherein a first groove for at least partially exposing the first sliding linkage and a second groove for at least partially exposing the second sliding linkage are provided on the cavity phase shifter, wherein the first groove and the second groove are arranged side by side in the horizontal direction, and a dimension of the second groove is different from a dimension of the first groove.

2. The cavity phase shifter of claim 1, wherein a length of the first groove is greater than a length of the second groove.

3. The cavity phase shifter of claim 2, wherein the first groove comprises a main section and an extended section extending along a longitudinal direction from the main section.

4. The cavity phase shifter of claim 3, wherein the length dimension of a main section of the second groove is substantially the same as the length dimension of the main section of the first groove.

5. The cavity phase shifter of claim 3, wherein the first groove comprises a first extended section located at a first side of the main section and a second extended section located at a second side of the main section.

6. The cavity phase shifter of claim 5, wherein the dimension of the first extended section is the same as the dimension of the second extended section.

7. The cavity phase shifter of claim 1, wherein a length of the first groove is between 110% and 200% of a length of the second groove.

8. The cavity phase shifter of claim 3, wherein an average width of the extended section of the first groove is less than an average width of the main section.

9. The cavity phase shifter of claim 1, wherein an average width of the first groove is greater than an average width of the second groove.

10. The cavity phase shifter of claim 1, wherein the first groove and the second groove are arranged side by side with each other on a rear surface of the cavity phase shifter in the horizontal direction.

11. The cavity phase shifter of claim 1, wherein the first cavity and the second cavity are spaced apart from each other in the horizontal direction via one transition face such that the first groove and the second groove are spaced apart from each other in the horizontal direction.

12. The cavity phase shifter of claim 1, wherein the first cavity and the second cavity are formed as an offset cavity pair, wherein the first cavity and the second cavity are attached to each other in the horizontal direction and separated by a common separation wall such that the first groove and the second groove are attached to each other in the horizontal direction and separated by the separation wall.

13. The cavity phase shifter of claim 12, wherein the first cavity has a first hollow channel protruding rearward and the second cavity has a second hollow channel protruding rearward, wherein one transition face is formed between the first hollow channel and the second hollow channel, and within regions of the first groove and the second groove, not only a first hollow channel section and a second hollow channel section, but also a transition face section therebetween are excised.

14. The cavity phase shifter of claim 12, wherein the cavity phase shifter is formed as a cavity phase shifter for multi-frequency band operation, wherein the cavity phase shifter comprises two offset cavity pairs, and the two offset cavity pairs are spaced apart from each other in the horizontal direction via one transition face.

15. The cavity phase shifter of claim 1, wherein a dimension of the second groove is designed to be different from a dimension of the first groove such that at least one resonant frequency point of a radio frequency characteristic curve of the cavity phase shifter is transferred outside its operating frequency band.

16. The cavity phase shifter of claim 15, wherein the radio frequency characteristic curve comprises a return loss characteristic curve, an insertion loss characteristic curve, and/or an isolation characteristic curve.

17. A cavity phase shifter, comprising:
a first cavity;
a first main phase shifter circuit, a first moveable phase shift component assigned to the first main phase shifter circuit, and a first sliding linkage for the first moveable phase shift component that are each mounted in the first cavity;
a second cavity;
a second main phase shifter circuit, a second moveable phase shift component assigned to the second main phase shifter circuit, and a second sliding linkage for the second moveable phase shift component that are each mounted in the second cavity,
wherein the first cavity and the second cavity are arranged side by side in a horizontal direction,
wherein a first groove for at least partially exposing the first sliding linkage and a second groove for at least partially exposing the second sliding linkage are provided on the cavity phase shifter, the first groove and the second groove are arranged side by side in the horizontal direction, wherein the first groove and the second groove are differently designed such that a first resonant frequency point caused by the first groove is different from a second resonant frequency point caused by the second groove.

18. The cavity phase shifter of claim 17, wherein the first groove and the second groove are differently designed such that at least one resonant frequency point of a radio frequency characteristic curve of the cavity phase shifter is transferred outside of its operating frequency band.

19. The cavity phase shifter of claim 18, wherein the radio frequency characteristic curve comprises a return loss characteristic curve, an insertion loss characteristic curve, and/or an isolation characteristic curve.

20. The cavity phase shifter of claim 17, wherein the first groove and the second groove are differently designed in terms of dimensions and/or shapes.

21. The cavity phase shifter of claim 20, wherein the first groove and the second groove are differently designed in terms of length dimensions and/or width dimensions.

22. A cavity phase shifter, comprising:
a first metal cavity having a first opening that exposes a first sliding linkage that is mounted within the first metal cavity;
a second metal cavity having a second opening that exposes a second sliding linkage that is mounted within the second metal cavity;
wherein a size of the first opening is different than a size of the second opening.

23. The cavity phase shifter of claim 22, wherein a first phase shifter circuit is mounted within the first metal cavity and a second phase shifter circuit is mounted within the second metal cavity, and the first metal cavity and the second metal cavity are arranged side by side to each other in a horizontal direction.

24. The cavity phase shifter of claim 23, wherein the first opening is a first groove and the second opening is a second groove.

25. The cavity phase shifter of claim 24, wherein the first groove and the second groove are arranged side by side with each other in the horizontal direction.

26. The cavity phase shifter of claim 25, wherein the first groove has a first length and a first width, and the second groove has a second length and a second width, and the first length is at least 10% longer than the second length.

27. The cavity phase shifter of claim 25, wherein the first groove comprises a first main section that has a first length and a first width and an extended section extending along a longitudinal direction from the main section, the extended section having a width that is different than the main width.

28. The cavity phase shifter of claim 27, wherein the second groove comprises a second main section that has a second length and a second width, wherein the second length is substantially the same as the first length.

29. A base station antenna, comprising:
a cavity phase shifter according to claim 22;
a radiating element array mounted in front of the cavity phase shifter;
a remote electronic tilt unit, wherein a first member of the remote electronic tilt unit is configured to connect to the first sliding linkage exposed via the first groove, and a second member of the remote electronic tilt unit is configured to connect to the second sliding linkage exposed via the second groove.
